(19) United States
(12) Patent Application Publication
(10) Pub. No.: US 2022/0136805 A1
(43) Pub. Date: May 5, 2022

(54) FLEXIBLE VAULT BALLISTIC PANEL AND BALLISTIC PANEL ACCESSORIES

(71) Applicant: William B. McMurray, Detroit, MI (US)

(72) Inventor: William B. McMurray, Detroit, MI (US)

(21) Appl. No.: 17/514,476

(22) Filed: Oct. 29, 2021

Related U.S. Application Data
(60) Provisional application No. 63/107,283, filed on Oct. 29, 2020.

(51) Int. Cl. F41H 5/04; F41H 5/08; B32B 5/02; B32B 5/26; B32B 15/14; B32B 15/02

(52) U.S. Cl. CPC F41H 5/0485; F41H 5/08; B32B 5/024; B32B 5/263; B32B 2262/103; B32B 15/02; B32B 2571/02; B32B 2307/732; B32B 2262/0269; B32B 15/14

(57) ABSTRACT

A ballistic panel and a ballistic panel assembly that absorb and stops high velocity projectiles is provided. The ballistic panel includes a first layer assembly with a first plurality of weave mesh layers, a second layer assembly with a second plurality of weave mesh layers, and a third solid layer sandwiched between the first layer assembly and the second layer assembly. The ballistic panel assembly can include a releasably attachable GPS tracking chip, an alert signaling device, and/or an outer electromagnetic shield.

### FIELD

The present disclosure relates to a ballistic panel and particularly to personal protective equipment with one or more ballistic panels.

### BACKGROUND

The statements in this section merely provide background information related to the present disclosure and may not constitute prior art.

Situations where an “active shooter” is present at a location can result in an individual needing protection from the active shooter and the use of a ballistic panel can provide some form of protection. That is, ballistic panels provide protection against high velocity projectiles and generally include one or more layers that absorb and dissipate energy from the projectiles upon impact. Common layers used for such ballistic panels include steel and/or ceramic layers which can significantly increase weight and bulk of an object in which or on which the ballistic panel is attached.

The present disclosure addresses the issues of heavy and bulky ballistic panels among other issues related to ballistic panels.

### SUMMARY

This section provides a general summary of the disclosure and is not a comprehensive disclosure of its full scope or all of its features.

In one form of the present disclosure, a ballistic panel includes a first layer assembly with a first plurality of weave mesh layers, a second layer assembly with a second plurality of weave mesh layers, and a third solid layer sandwiched between the first layer assembly and the second layer assembly.

In another form of the present disclosure, a ballistic panel includes a first layer assembly with between 20 and 30 weave mesh layers, a second layer assembly with 20 and 30 weave mesh layers, and a third polycarbonate layer with a thickness between about 0.10 inches and 0.25 inches sandwiched between the first layer assembly and the second layer assembly.

In still another form of the present disclosure, a ballistic panel assembly includes a first layer assembly with between 20 and 30 weave mesh poly-paraphenylene terephthalamide fiber layers, a second layer assembly comprising 20 and 30 weave mesh poly-paraphenylene terephthalamide fiber layers, a third polycarbonate layer with a thickness between about 0.10 inches and 0.25 inches sandwiched between the first layer assembly and the second layer assembly, and an outer cover formed from at least one of nylon fabric and polyurethane, wherein the first layer assembly, the second layer assembly, and the third polycarbonate layer are disposed within the outer cover.

The description and specific examples in this summary are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a ballistic panel according to the teachings of the present disclosure;

FIG. 2 is a cross-sectional view of section 2-2 in FIG. 1 according to one form of the present disclosure;

FIG. 3 is a cross-sectional view of section 2-2 in FIG. 1 according to another form of the present disclosure;

FIG. 4 is a cross-sectional view of a ballistic panel assembly with the ballistic panel in FIG. 1 disposed within an outer cover according to the teachings of the present disclosure;

FIG. 5 is a perspective view of a ballistic panel according to still another form of the present disclosure;

FIG. 6 is a cross-sectional view of section 6-6 in FIG. 5 according to the teachings of the present disclosure;

FIG. 7 is a cross-sectional view of a ballistic panel assembly with the ballistic panel in FIG. 5 disposed within an outer cover according to the teachings of the present disclosure;

FIG. 7A is block diagram for an electronic device shown in FIG. 7;

FIG. 8 is a cross-section view of the ballistic panel assembly in FIG. 7 disposed in an outer electromagnetic shield cover according to the teachings of the present disclosure;

FIG. 9 is perspective view of a backpack with a ballistic panel according to the teachings of the present disclosure;

FIG. 10 is perspective view of a briefcase with a ballistic panel according to the teachings of the present disclosure;

FIG. 11 is perspective view of a purse with a ballistic panel according to the teachings of the present disclosure;

FIG. 12 is perspective view of a gym bag with a ballistic panel according to the teachings of the present disclosure;

FIG. 13 is perspective view of a grocery bag with a ballistic panel according to the teachings of the present disclosure;

FIG. 14 is perspective view of a beach bag with a ballistic panel according to the teachings of the present disclosure;

FIG. 15 is perspective view of a piece of luggage with a ballistic panel according to the teachings of the present disclosure;

FIG. 16 is perspective view of an article of clothing with a ballistic panel according to the teachings of the present disclosure;

FIG. 17 is a photograph of a ballistic panel assembly with a pair of ballistic panels according to the teachings of the present disclosure;

FIG. 18 is a photograph of a backpack with the ballistic panel assembly in FIG. 12 inside of the backpack;

FIG. 19 is a photograph of the backpack in FIG. 13 after one of the ballistic panels inside the backpack has been hit with a first projectile;

FIG. 20 is a photograph of the backpack in FIG. 14 another of the ballistic panels inside the backpack has been hit with a plurality of projectiles; and

FIG. 21 is a photograph of the plurality of projectiles after being retrieved from the ballistic panel assembly.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. Examples are provided to fully convey the scope of the disclosure to those who are skilled in the art. Numerous specific details are set forth such as types of specific components, devices, and methods, to provide a thorough understanding of variations of the present disclosure. It will be apparent to those skilled in the art that specific details need not be employed and that the examples provided herein, may include alternative embodiments and are not intended to limit the scope of the disclosure. In some examples, well-known processes, well-known device structures, and well-known technologies are not described in detail.

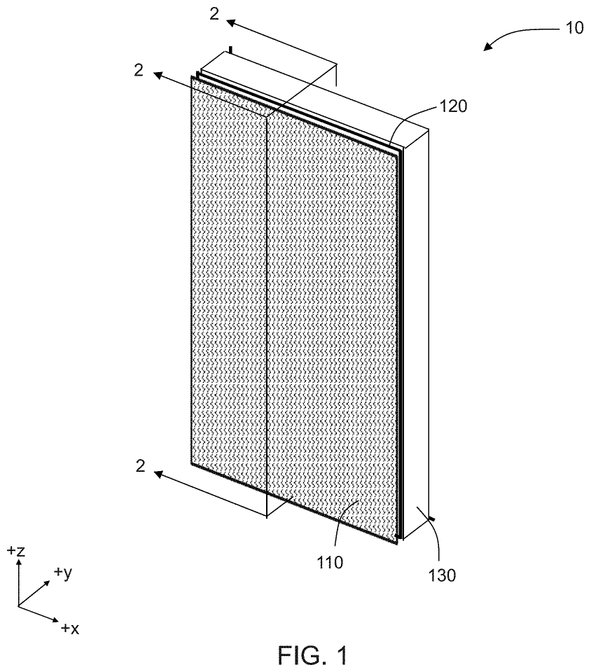

Referring to FIG. 1, a perspective view of a ballistic panel 10 according to one form of the present disclosure is shown. The ballistic panel 10 includes a first layer 110, a second layer 120, and a third layer 130. In some variations the first layer 110 is a first weave mesh layer 110, the second layer 120 is a second weave mesh layer 120, and the third layer 130 is a solid layer 130, i.e., not a weave mesh layer. Non-limiting examples of the first layer 110 include a metallic weave mesh layer 110 such as a stainless steel weave mesh layer, a steel weave mesh layer, a nickel or nickel alloy weave mesh layer, a titanium or titanium alloy weave mesh layer, an aluminum or aluminum alloy weave mesh layer, among others.

Non-limiting examples of the second layer 120 include a synthetic fiber weave mesh layer such as a poly-paraphenylene terephthalamide fiber (also known as Kevlar®) weave mesh layer, an aramid fiber weave mesh layer, a carbon fiber weave mesh layer, a carbon precursor fiber weave mesh layer, a poly-phenylene benzo-bisoxazole (PBO) fiber weave mesh layer, a polybenzimidazole (FBI) fiber weave mesh layer, a fluorocarbon fiber weave mesh layer, among others. Non-limiting examples of third layer 130 include polymer layers such a polycarbonate layer, a polypropylene layer, an acrylic layer, among others.

In some variations, the first layer 110 and the second layer 120 have a thickness (z direction) of between 0.03 inches (in.) and 0.25 in., for example between 0.06 in and 0.20 in., or between 0.12 in. and 0.20 in. In at least one variation the first layer 100 and the second layer 120 have the same thickness, while in other variations the first layer 100 and the second layer 120 do not have the same thickness.

In some variations the third layer 130 has a thickness between 0.10 in. and 0.50 in., for example between 0.12 in. and 0.40 in, between 0.15 in. and 0.30 in., or between 0.175 in. and 0.250 in. In at least one variation, the third layer is 0.250 inches thick.

While FIG. 1, and other figures herein, show the second layer 120 disposed between the first layer 110 and the third layer 130, in some variations the first layer 110 is disposed between the second layer 120 and the third layer 130, while in other variations the third layer 130 is disposed between the first layer 110 and the second layer 120.

In some variations the first layer 110, the second layer 120, and/or the third layer 130 are bound or attached to each other. For example, in at least one variation the first layer 110 is attached to the second layer 120 and the second layer 120 is not attached to the third layer 130, while in another variation the first layer 110 is not attached to the second layer 120 and the second layer 120 is attached to the third layer 130. In some variations, the first layer 110 is attached to the second layer 120 and the second layer 120 is attached to the third layer 130, i.e., all the layers are attached to each other. And in at least one variation the first layer 110 is not attached to the second layer 120 and the second layer 120 is not attached to the third layer 130, i.e., none of the layers are attached to each other. In variations where one or more of the layers are attached to each other, the layers can be attached to each other using techniques such as adhesives, mechanical fasteners, ultrasonic welding, among others.

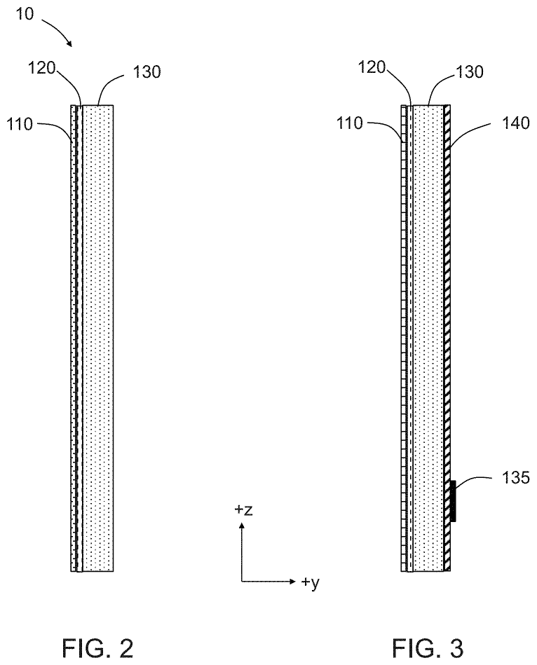

Referring to FIG. 2, a cross sectional view of section 2-2 in FIG. 1 is shown. Particularly, the ballistic panel 10 has the first layer 110 adjacent to the second layer 120 which is adjacent to the third layer 130.

As mentioned above, in some variations the ballistic panel 10 includes more than three layers. For example, and with reference to FIG. 3, a non-limiting example of the ballistic panel 10 with a fourth layer 140 is shown. In some variations the fourth layer 140 is a metallic mesh weave layer that blocks or obstructs radio frequency identification (RFID) transmission. That is, the fourth layer 140 is an RFID blocking layer. Non-limiting examples of the fourth layer 140 include a nickel-copper fabric layer, an aluminum foil layer, among others. It should be understood that the ballistic panel 10 can include even more layers, including but not limited to two or more first layers 110, two or more second layers 120, two or more third layers 130, two or more fourth layers 140, one or more fifth layers (not shown), and/or one or more sixth layers (not shown), among others. In addition, in some variations the ballistic panel 10 includes a GPS tracking chip 135 which provide for GPS tracking of the ballistic panel 10.

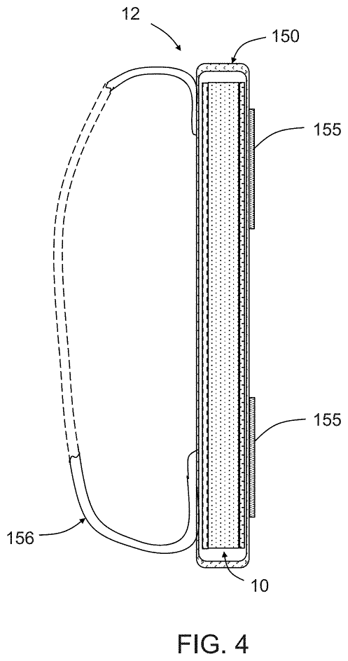

Referring to FIG. 4, in another form of the present disclosure a ballistic panel assembly 12 includes the ballistic panel 10 disposed within an outer cover 150. In some variations, the ballistic panel 10 is removably disposed within the outer cover 150. That is, the outer cover 150 has an opening (not labeled) for placement of the ballistic panel 10 within and removal from the outer cover 150. In such variations the outer cover 150 can be “closed” using a device or technique such as hook and loop fasteners, a zipper, a lock, among others, in order to inhibit undesired removal of the ballistic panel 10 from the outer cover 150. In other variations, the outer cover 150 does not have an opening for removal of the ballistic panel 10 once disposed in the outer cover 150. For example, the outer cover 150 can be sewn and/or sealed such that the ballistic panel 10 cannot be removed from the outer cover 150 without damaging (e.g., cutting) the outer cover 150. In addition, in some variations the outer cover 150 includes one or more attachment regions or patches 155 that provide for the ballistic panel assembly 12 to be attached to another object (not shown in FIG. 4). Non-limiting examples of material from which the outer cover 150 is made include nylon, cloth, metallic mesh weave, among others. And non-limiting examples of the one or more attachment regions 155 include hook and loop fasteners, adhesive tape, magnetics, among others. In the alternative, or in addition to, the ballistic panel assembly 12 can include one or more straps 156 (only one shown in FIG. 4) that provide for user to hold the ballistic panel assembly 12. For example, two straps 156 can be attached to the outer cover 150 (e.g., by sewing and/or adhesives) such an individual can pass one or both arms through the straps 156 and use or hold the ballistic panel assembly 12 as a shield.

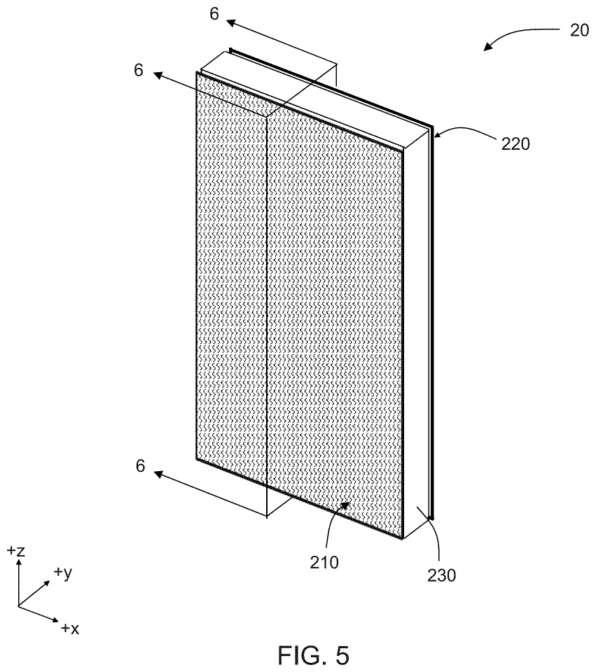

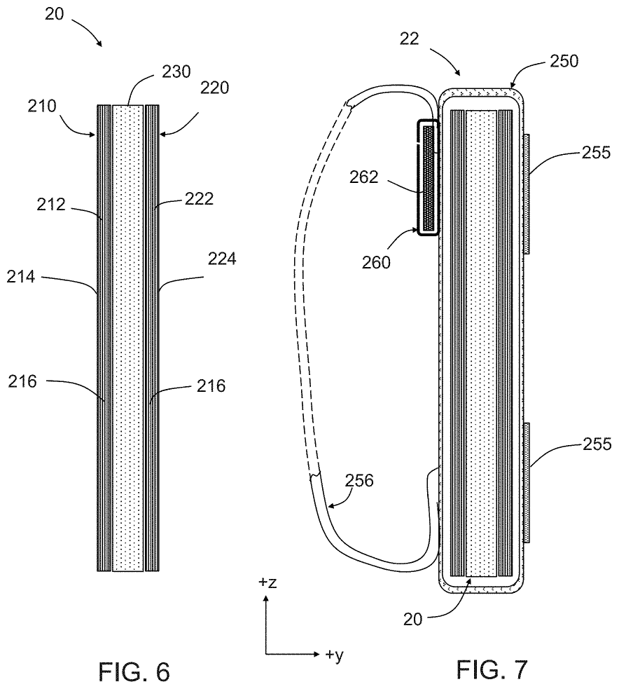

Referring to FIGS. 5 and 6, a perspective view of a ballistic panel 20 according to still another form of the present disclosure is shown in FIG. 5 and a cross-sectional view of section 6-6 in FIG.5 is shown in FIG. 6. The ballistic panel 20 includes a first layer assembly 210, a second layer assembly 220, and a third layer 230. In some variations the first layer assembly 210 includes a first plurality of weave mesh layers 212, the second layer assembly 220 includes a second plurality of weave mesh layers 222, and the third layer 230 is a solid layer 230. Non-limiting examples of the plurality of weave mesh and the plurality of weave mesh layers 222 include a metallic weave mesh layers such as stainless steel weave mesh layers, steel weave mesh layers, nickel or nickel alloy weave mesh layers, titanium or titanium alloy weave mesh layers, aluminum or aluminum alloy weave mesh layers, among others. In the alternative, or in addition to, the plurality of weave mesh layers 212 and the plurality of weave mesh layers 222 include synthetic fiber weave mesh layers such as poly-paraphenylene terephthalamide fiber weave mesh layer, aramid fiber weave mesh layers, carbon fiber weave mesh layers, carbon precursor fiber weave mesh layers, PBO fiber weave mesh layers, PBI fiber weave mesh layers, poly-paraphenylene terephthalamide weave mesh layers, fluorocarbon fiber weave mesh layers, among others. In some variations, the weave mesh layers 212, 222 are formed with fibers with a linear mass density between about 600 denier and 1000 denier, and in at least one variation the weave mesh layers 212, 222 are formed with fibers with a linear mass density of about 850 denier. As used herein, the term “denier” refers to mass in grams per 9000 meters of fiber. And non-limiting examples of third layer 230 include polymer layers such a polycarbonate layer, a polypropylene layer, an acrylic layer, among others.

In some variations, each of the plurality of weave mesh layers 212, 222 include between 10 and 50 weave mesh layers 212, 222 (i.e., the plurality of weave mesh layers 212 includes between 10 and 50 weave mesh layers 212 and the plurality of weave mesh layers 222 includes between 10 and 50 weave mesh layers. In at least one variation, each of the plurality of weave mesh layers 212, 222 include between 15 and 40 weave mesh layers 212, 222, and in some variations each of the plurality of weave mesh layers 212, 222 include between 20 and 30 weave mesh layers 212, 222. In at least one variations, each of the plurality of weave mesh layers 212, 222 include 24 weave mesh layers 212, 222.

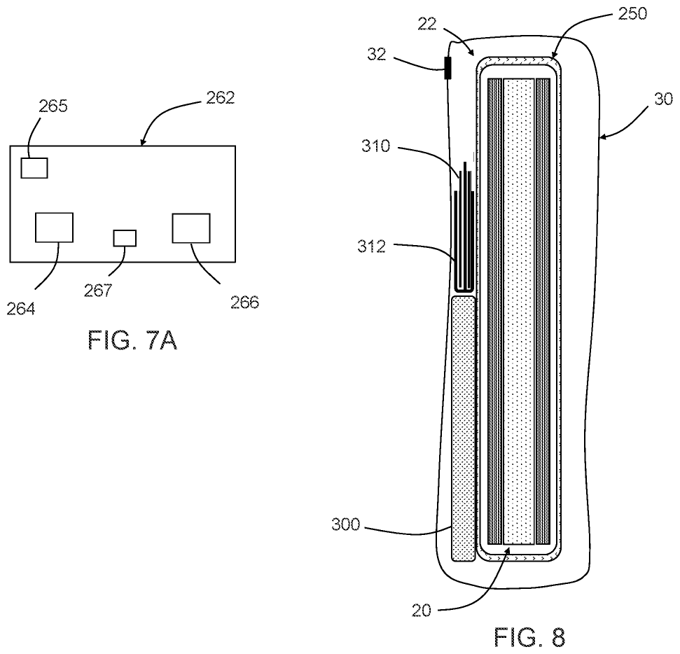

In some variations the plurality of weave mesh layers 212, 222 are “loose” layers, i.e., the plurality of layers 212, 222 are not bounded to each other and/or contained within an outer cover (e.g., outer cover 250 in FIG. 7), while in other variations the plurality of weave mesh layers 212 are contained within a sleeve 214 and/or the plurality of weave mesh layers 222 are contained within a sleeve 224. In some variations, the sleeve 214 and/or the sleeve 224 is formed from nylon weave. In the alternative, or in addition to, the plurality of weave mesh layers 212 are bonded together with a resin or adhesive 216 and/or the plurality of weave mesh layers 222 are bonded together with a resin or adhesive 226. In addition, the plurality of weave mesh layers 212 and/or the plurality of weave mesh layers 222 may or may not be bonded to the third layers 230, e.g., with an adhesive, hook and loop fasteners, and the like.

In some variations the third layer 230 has a thickness between 0.10 in. and 0.50 in., for example between 0.12 in. and 0.40 in, between 0.15 in. and 0.30 in., or between 0.175 in. and 0.250 in. In at least one variation, the third layer is 0.125 in thick.

Referring to FIG. 7, in another form of the present disclosure a ballistic panel assembly 22 includes the ballistic panel 20 disposed within an outer cover 250. In some variations, the ballistic panel 20 is removably disposed within the outer cover 250. That is, the outer cover 250 has an opening (not labeled) for placement of the ballistic panel 20 within and removal from the outer cover 250. In such variations the outer cover 250 can be “closed” using a device or technique such as hook and loop fasteners, a zipper, a lock, among others, in order to inhibit undesired removal of the ballistic panel 20 from the outer cover 250. In other variations, the outer cover 250 does not have an opening for removal of the ballistic panel 20 once disposed in the outer cover 250. For example, the outer cover 250 can be sewn and/or sealed such that the ballistic panel 20 cannot be removed from the outer cover 250 without damaging (e.g., cutting) the outer cover 250. In addition, in some variations the outer cover 250 includes one or more attachment regions or patches 255 that provide for the ballistic panel assembly 22 to be attached to another object (not shown in FIG. 7). Non-limiting examples of material from which the outer cover 250 is made include nylon, cloth, polyester knit, woven polyester base with an integral rubberized PVC surface, metallic mesh weave, among others. In addition, the outer cover 250 can be made from layers that are stitched or sewn together, e.g., using nylon thread such as T90 anefil nylon thread. And non-limiting examples of the one or more attachment regions 255 include hook and loop fasteners, adhesive tape, magnetics, among others. In the alternative, or in addition to, the ballistic panel assembly 22 can include one or more straps 256 (only one shown in FIG. 7) that provide for user to hold the ballistic panel 22. For example, two straps 256 can be attached to the outer cover 250 (e.g., by sewing and/or adhesives) such an individual can pass one or both arms through the straps 256 and use or hold the ballistic panel assembly 22 as a shield.

In some variations, the ballistic panel assembly 22 includes a pocket 260 configured to hold an electronic device 262. Non-limiting examples of the electronic device 262 include a GPS tracking chip, an alert signaling device (e.g., an active shooter alert device), among others. In some variations, the electronic device is a combination of a GPS tracking chip and an alert signaling device. For example, and with reference to FIG. 7A, a non-limiting example of a block diagram for the electronic device 262 with a GPS tracking chip 264 and an alert signaling device 266 is shown. In some variations a battery 265 is included (e.g., a rechargeable battery and/or a replaceable battery) and a switch 267 configured to stop or terminated functioning of the GPS tracking chip 264 and/or the alert signaling device 266. The GPS tracking chip 264 and the alert signaling device 266 are configured for wireless connectivity to a controlling device such as a computer(s) (e.g., a computer at a 911 emergency response station, a computer at one or more homes, a computer at an office where an individual works, among others), one or more cellular phones, among others.

In some variations the pocket 260 is releasable from the ballistic panel assembly 22 (i.e., releasably attached) such that an individual can quickly grasp and remove (e.g., within 1 second) the pocket 260 with the electronic device 262 from the ballistic panel assembly 22.

Referring to FIG. 8, in some variations an outer electromagnetic shield 30 is provided, and in such variations, the ballistic panel assembly 12 and/or 22, and/or additional items and devices can be placed within the outer electromagnetic shield 30. For example, FIG. 8 shows the ballistic panel assembly 22, an electronic device 300 (e.g., a cell phone), and one or more credit cards 310 in a wallet 312 placed within the outer electromagnetic shield 30. The outer electromagnetic shield 30 can include a closable opening 32 (e.g., a zipper, hook and loop fastener seam, among others) such that the outer electromagnetic shield 30 can be opened, the ballistic panel assembly 22 and/or other items and devices can be placed within the outer electromagnetic shield 30, and then the closable opening 32 closed such that the ballistic panel assembly 22 and/or other items and device are securely contained within the outer electromagnetic shield 30.

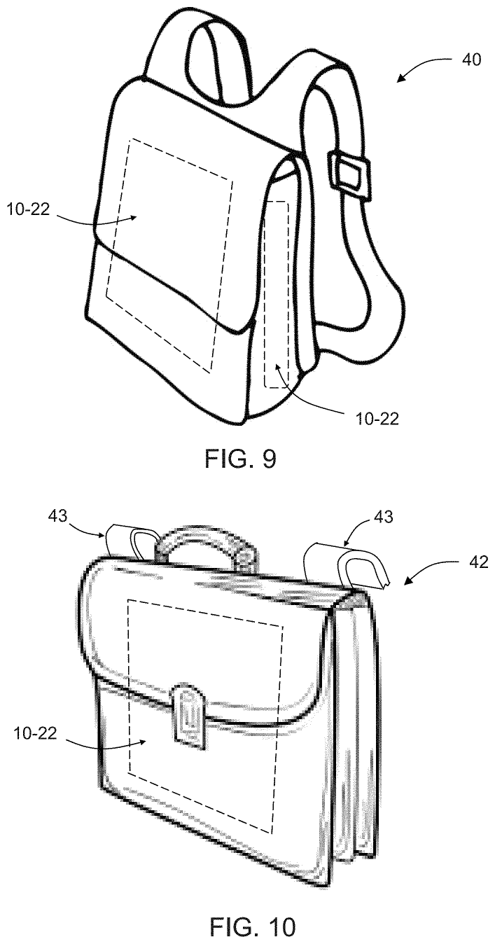

Referring now to FIGS. 9-21, examples of the ballistic panel 10 and/or the ballistic panel assembly 12, 22 (collectively referred to herein as “ballistic panel 10-22”) disposed within a separate object are shown. For example, FIG. 9 shows at least one ballistic panel 10-22 disposed within and/or attached to a backpack 40. In some variations, the backpack 40, and other separate objects described herein, has predefined and fabricated pockets or openings for the one or more ballistic panels 10-22. That is, the backpack 40 is designed and fabricated to include the one or more ballistic panels 10-22. In at least one variation, the one or more ballistic panels 10-22 cannot be removed from the backpack 40 without damaging the backpack 40. In other variations, the one or more ballistic panels 10-22 can be removed from the backpack 40 without damaging the backpack 40. And in some variations, the backpack 40, and other objects described herein, do not have predefined and fabricated pockets or openings for the one or more ballistic panels 10-22, and the one or more ballistic panels 10-22 are simply placed within the backpack 40 like other objects (e.g., books) carried by the backpack 40 and/or attached to the backpack 40 using attachment regions 155, 255. Accordingly, the backpack 40 with the one or more ballistic panels 10-22 can be fabricated as a single unit, or in the alternative, the backpack 40 can be fabricated and the one or more ballistic panels 10-22 added later.

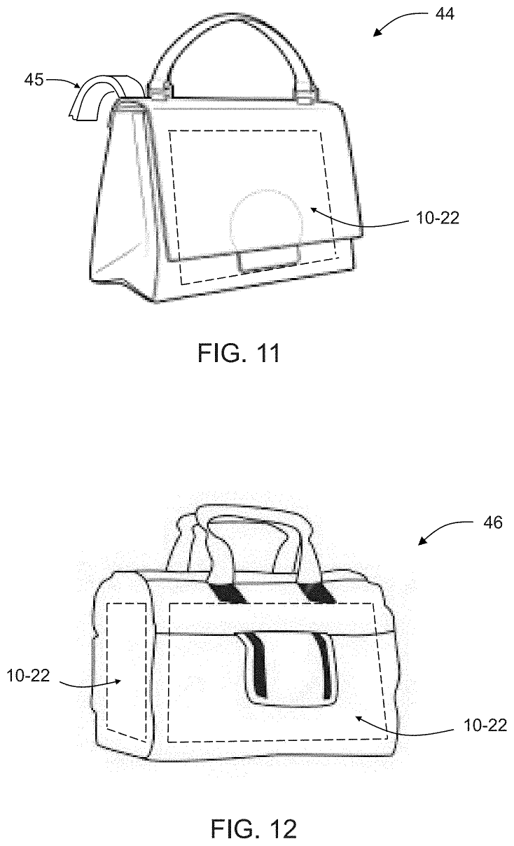

Referring to FIG. 10, a briefcase 42 with one or more ballistic panels 10-22 is shown and FIG. 11 shows a purse 44 with one or more ballistic panels 10-22. In some variations, the briefcase 42 and the purse 44, and other separate objects disclosed herein, can include one or straps 43 and 45, respectively, similar to the straps 156, 256 discussed above. For example, the briefcase 42 can include two straps 43 such that an individual can pass one or both arms through the straps 43 and use the briefcase 42 and the one or more ballistic panels 10-22 as a shield. And the purse 44 can include two straps 45 such that an individual can pass one or both arms through the straps 45 and use the purse 44 and the one or more ballistic panels 10-22 as a shield.

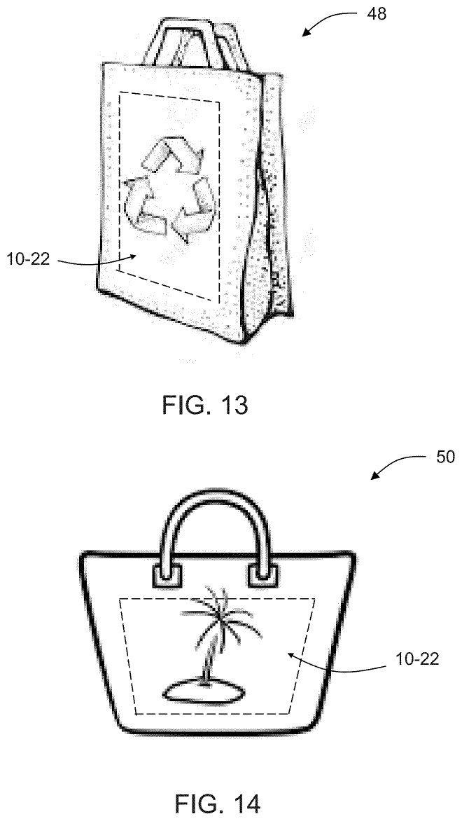

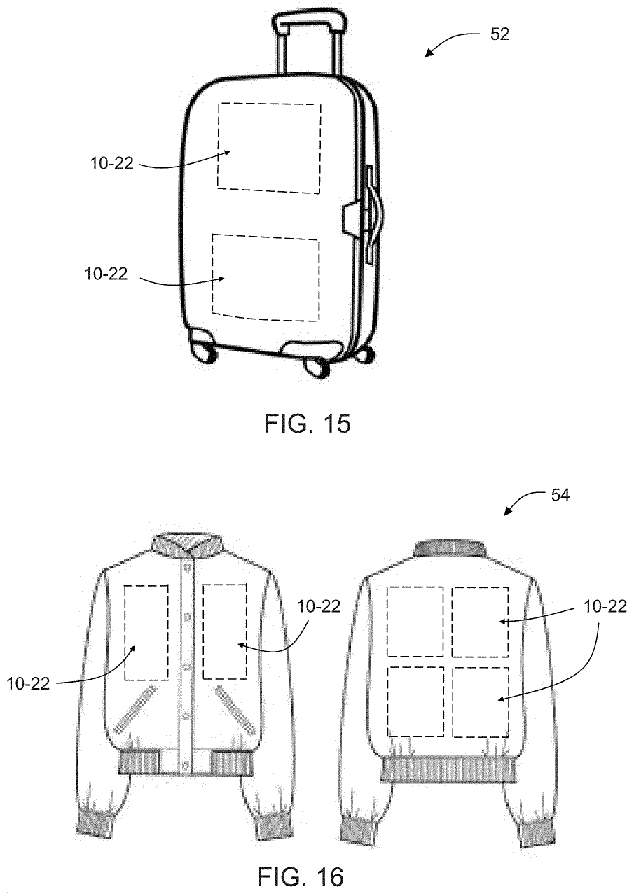

FIG. 12 shows a gym bag 46 with one or more ballistic panels 10-22, FIG. 13 shows a reusable shopping bag 48 with one or more ballistic panels 10-22, FIG. 14 shows a beach bag 50 with one or more ballistic panels 10-22, and FIG. 15 shows a piece of luggage 52 with one or more ballistic panels 10-22. And while FIGS. 9-15 show the one or more ballistic panels 10-22 disposed in an object that is typically carried by an individual, FIG. 16 shows a plurality of ballistic panels 10-22 disposed in a piece of clothing 54 (e.g., a jacket) that is worn by an individual.

Accordingly, it should be understood that the ballistic panel 10-22 can be used and disposed within any number of separate objects typically carried or worn by an individual and be present, without being noticeable, when needed.

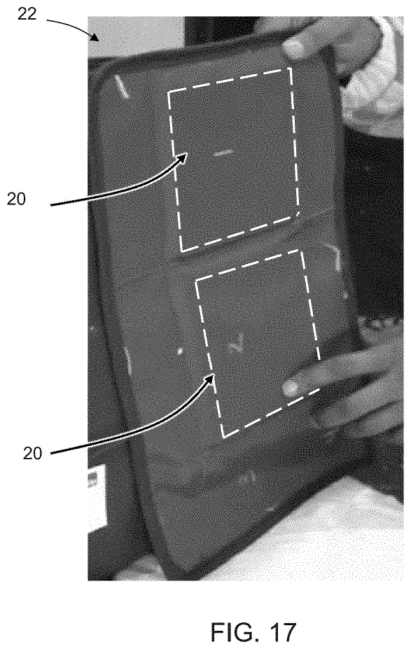

Referring to FIGS. 17-21, photographs of a ballistic panel assembly 22 used for testing and tested are shown. Referring particularly to FIG. 17, the ballistic panel assembly 22 had two ballistic panels 20 disposed within an outer cover 250 and each of the ballistic panels 20 had a first layer assembly 210 formed from twenty-four weave mesh layers 212, a second layer assembly 220 formed from twenty-four weave mesh layers 222, and a third layer 230 formed from polycarbonate and having a thickness of 0.22 in.

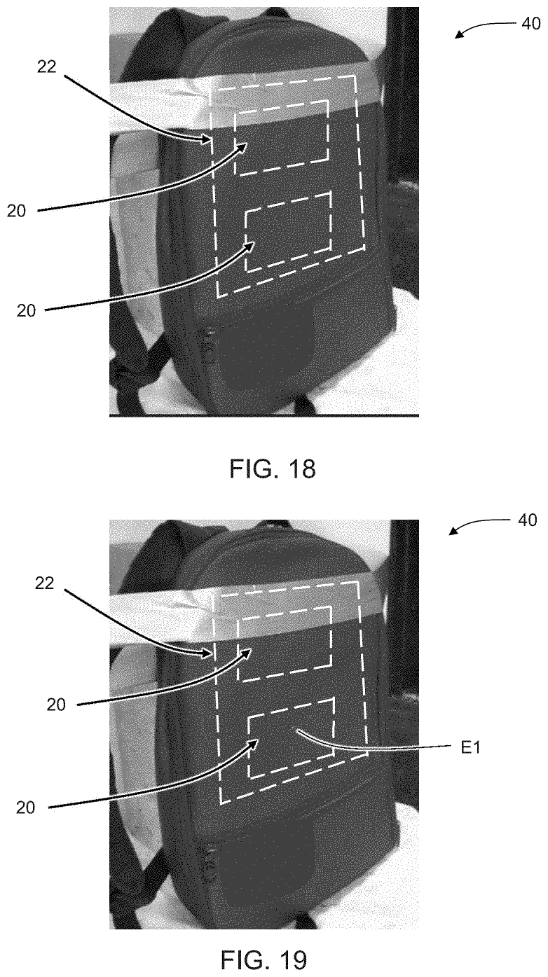

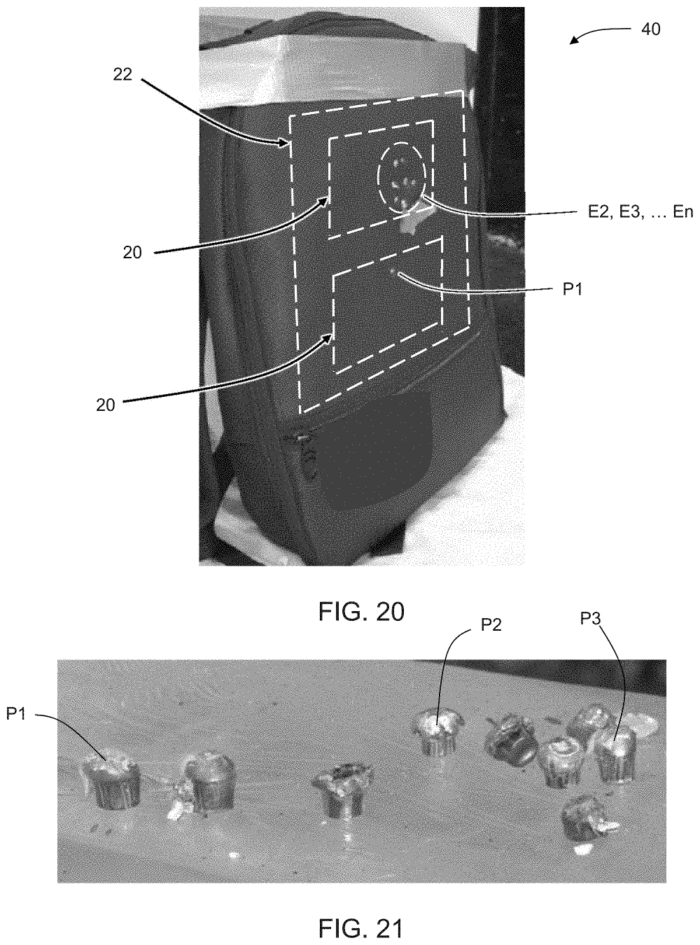

Referring to FIG. 18, the ballistic panel assembly 22 was placed inside a backpack 40 and projectiles (i.e., bullets) were fired at the backpack 40 and ballistic panel assembly 22 from close range, i.e., from a distance of about 10 to 15 feet. The backpack 40 was secured to a wall with duct tape shown but not labeled in the figures. FIG. 19 shows the backpack 40 with a single entry point ‘E1’ resulting from being struck or impacted by a first projectile in the form of a 9 millimeter (mm) bullet fired from a handgun, and FIG. 20 shows the backpack 40 with a plurality of entry points ‘E2, E3, . . . En’ resulting from being struck by a plurality of projectiles in the form of 9 mm and 0.45 caliber bullets fired from handguns.

After the testing, i.e., after shooting at the backpack 40, the backpack 40 was inspected and a plurality of projectiles P1, P2, . . . Pn shown in FIG. 21 were removed from within the outer cover 250, and no projectiles were present outside of the outer cover 250. That is, the ballistic panel assembly 22 successfully stopped nine (9) projectiles in the form of bullets fired at the backpack 40.

It should be understood that such test results demonstrate the ballistic panel assembly 22 could be used during an active shooter situation to protect an individual. Also, the ballistic panels disclosed herein can be light weight and less costly compared to known ballistic panels, can include one or more RFID blocking layers, and can include a GPS tracking chip that provides location information for or of an individual carrying a ballistic panel is located. In addition, the ballistic panel assembly 22 is bullet resistant as tested per NIJ 0108.01, slash resistant as tested per NIJ Standard 0115.00, flame resistant as tested per ASTM D635, water resistant as tested per ASTM D571, and tamper resistant as tested per CA DOJ. Also, the outer electromagnetic shield 30 prevents RFID scanning of magnetic strips, chips, and micro-processors as tested under DOD and commercial certification USTL 2018.

Accordingly, it should be understood from the teachings of the present disclosure that enhanced personal protective equipment is provided and such personal protective equipment can assist an individual during potentially harmful events such as an active shooter event, a knife attack, among others.

When an element or layer is referred to as being “on,” “engaged to,” or “coupled to,” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spacially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, examples that do not depart from the substance of the disclosure are intended to be within the scope of the disclosure. Such examples are not to be regarded as a departure from the spirit and scope of the disclosure. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A ballistic panel comprising:
a first layer assembly comprising a first plurality of weave mesh layers;
a second layer assembly comprising a second plurality of weave mesh layers; and
a third solid layer sandwiched between the first layer assembly and the second layer assembly.

2. The ballistic panel according to claim 1, wherein the first plurality of weave mesh layers comprises between 20 and 30 poly-paraphenylene terephthalamide fiber layers.

3. The ballistic panel according to claim 2, wherein the second plurality of weave mesh layers comprises between another 20 and 30 poly-paraphenylene terephthalamide fiber layers.

4. The ballistic panel according to claim 3, wherein the first plurality of weave mesh layers and the second plurality of weave mesh layers comprise fibers with a linear mass density between about 600 denier and about 1000 denier.

5. The ballistic panel according to claim 4, wherein the third solid layer is a polycarbonate layer with a thickness between about 0.10 inches and about 0.250 inches.

6. The ballistic panel according to claim 5, wherein the first plurality of weave mesh layer is contained within a nylon weave sleeve and the second plurality of weave mesh layers is contained within another nylon weave sleeve.

7. The ballistic panel according to claim 1 further comprising an outer cover, wherein the first layer assembly, the second layer assembly, and the third solid layer are disposed within the outer cover.

8. The ballistic panel according to claim 7, wherein the outer cover is formed from at least one of nylon fabric and polyurethane.

9. The ballistic panel according to claim 8 further comprising at least one of a GPS tracking chip and an alert signaling device.

10. The ballistic panel according to claim 9, wherein the at least one of the GPS tracking chip and the alert signaling device are releasably attached to the outer cover.

11. The ballistic panel according to claim 10 further comprising at least one strap attached to the outer cover, wherein the at least one strap is configured for an arm of an individual to pass through such that the first layer assembly, the second layer assembly, and the third solid layer disposed within the outer cover is held as a shield.

12. The ballistic panel according to claim 7 further comprising an outer electromagnetic shield, wherein the first layer assembly, the second layer assembly, and the third solid layer disposed within the outer cover are disposed within the outer electromagnetic shield.

13. The ballistic panel according to claim 7 further comprising a separate object selected from the group consisting of backpack, a briefcase, a purse, a gym bag, a shopping bag, a beach bag, a piece of luggage, and a piece of clothing, wherein the first layer assembly, the second layer assembly, and the third solid layer disposed within the outer cover are disposed within the separate object.

14. A ballistic panel comprising:
a first layer assembly comprising between 20 and 30 weave mesh layers;
a second layer assembly comprising 20 and 30 weave mesh layers; and
a third polycarbonate layer with a thickness between about 0.10 inches and 0.25 inches sandwiched between the first layer assembly and the second layer assembly.

15. The ballistic panel according to claim 14, wherein weave mesh layers are poly-paraphenylene terephthalamide fiber layers.

16. The ballistic panel according to claim 15, wherein poly-paraphenylene terephthalamide fiber layers comprise fibers with a linear mass density between about 600 denier and about 1000 denier.

17. The ballistic panel according to claim 14 further comprising an outer cover formed from at least one of nylon fabric and polyurethane, and at least one of a GPS tracking chip and an alert signaling device releasably attached to the outer cover, wherein the first layer assembly, the second layer assembly, and the third polycarbonate layer are disposed within the outer cover.

18. The ballistic panel according to claim 17 further comprising at least one strap attached to the outer cover, wherein the at least one strap is configured for an arm of an individual to pass through such that the first layer assembly, the second layer assembly, and the third polycarbonate layer disposed within the outer cover is held as a shield.

19. A ballistic panel assembly comprising:
a first layer assembly comprising between 20 and 30 weave mesh poly-paraphenylene terephthalamide fiber layers;
a second layer assembly comprising 20 and 30 weave mesh poly-paraphenylene terephthalamide fiber layers;
a third polycarbonate layer with a thickness between about 0.10 inches and 0.25 inches sandwiched between the first layer assembly and the second layer assembly; and
an outer cover formed from at least one of nylon fabric and polyurethane, wherein the first layer assembly, the second layer assembly, and the third polycarbonate layer are disposed within the outer cover.

20. The ballistic panel assembly according to claim 19 further comprising at least one:
of a GPS tracking chip releasably attached to the outer cover;
an alert signaling device releasably attached to the outer cover; and
an outer electromagnetic shield configured to contain the ballistic panel assembly; and
at least one strap attached to the outer cover, wherein the at least one strap is configured for an arm of an individual to pass through such that the first layer assembly, the second layer assembly, and the third polycarbonate layer disposed within the outer cover is held as a shield.
